(19) United States
(12) Patent Application Publication
(10) Pub. No.: US 2007/0052696 A1
(43) Pub. Date: Mar. 8, 2007

(54) Information processing apparatus and system control method

(75) Inventor: Keiichi Uehara, Ome-shi (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Kabushiki Kaisha Toshiba

(21) Appl. No.: 11/503,469

(22) Filed: Aug. 11, 2006

(30) Foreign Application Priority Data
Aug. 29, 2005 (JP) 2005-247779

(51) Int. Cl. G09G 5/00

(52) U.S. Cl. 345/204

(57) ABSTRACT

According to one embodiment, an information processing apparatus includes a body, a processor provided within the body, a control device provided within the body and configured to control an operation of the body in conjunction with the processor, and a storing unit configured to store an image adjusting parameter. The control device includes a determination unit configured to determine whether or not an image processing controller is included in the body. The image processing controller performs, based on the image adjusting parameter, predetermined image processing with respect to image data to be displayed on a display apparatus. The control device also includes a setting unit configured to set, when the determination unit determines that the image processing controller is included in the body, the image adjusting parameter stored in the storing unit to the image processing controller.

### CROSS-REFERENCE TO RELATED APPLICATIONS

This application is based upon and claims the benefit of priority from Japanese Patent Application No. 2005-247779, filed Aug. 29, 2005, the entire contents of which are incorporated herein by reference.

### BACKGROUND

1. Field

One embodiment of the invention relates to an information processing apparatus such as a personal computer and to a system control method for use in the information processing apparatus.

2. Description of the Related Art

In recent years, various personal computers have been developed which include audio-video (AV) reproduction functions similar to those of AV equipment such as DVD (Digital Versatile Disc) players and TV sets.

For example, Japanese Patent Application Publication (KOKAI) No. 2002-108486 discloses a personal computer including a DVD driver and a TV tuner. In the computer disclosed in this publication, image data obtained from the TV tuner is processed by an image controller, and thereafter displayed on a display unit which is directly coupled to the image controller.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary perspective view showing the external appearance of an information processing apparatus according to an embodiment of the invention;

FIG. 2 is an exemplary block diagram showing a first exemplary system configuration of the information processing apparatus of FIG. 1;

FIG. 3 is an exemplary block diagram showing a second exemplary system configuration of the information processing apparatus of FIG. 1;

FIG. 4 is an exemplary block diagram for explaining exemplary functions and configuration of a control device provided in the information processing apparatus of FIG. 1;

FIG. 5 is an exemplary diagram for explaining a first exemplary determination process which is carried out by the information processing apparatus of FIG. 1;

FIG. 6 is an exemplary diagram for explaining a second exemplary determination process which is carried out by the information processing apparatus of FIG. 1;

FIG. 7 is an exemplary diagram showing exemplary functions and configuration of an image processing controller which is provided in the information processing apparatus of FIG. 1;

FIG. 8 is an exemplary diagram showing exemplary functions and configuration of a TV application program which is used in the information processing apparatus of FIG. 1;

FIG. 9 is an exemplary diagram showing a first exemplary setting screen related to an image quality adjusting process displayed on a display screen of the information processing apparatus of FIG. 1;

FIG. 10 is an exemplary diagram showing a second exemplary setting screen related to the image quality adjusting process displayed on the display screen of the information processing apparatus of FIG. 1; and

FIG. 11 is an exemplary flowchart for explaining an exemplary procedure of the image quality adjusting process which is carried out by the information processing apparatus of FIG. 1.

### DETAILED DESCRIPTION

Various embodiments according to the invention will be described hereinafter with reference to the accompanying drawings. In general, according to one embodiment of the invention, an information processing apparatus includes a body, a processor provided within the body, a control device provided within the body and configured to control an operation of the body in conjunction with the processor, and a storing unit configured to store an image adjusting parameter. The control device includes a determination unit configured to determine whether or not an image processing controller is included in the body. The image processing controller performs, based on the image adjusting parameter, predetermined image processing with respect to image data to be displayed on a display apparatus. The control device also includes a setting unit configured to set, when the determination unit determines that the image processing controller is included in the body, the image adjusting parameter stored in the storing unit to the image processing controller. With the information processing apparatus according to this embodiment, it is possible to control a plurality of kinds of system configurations by a single control device.

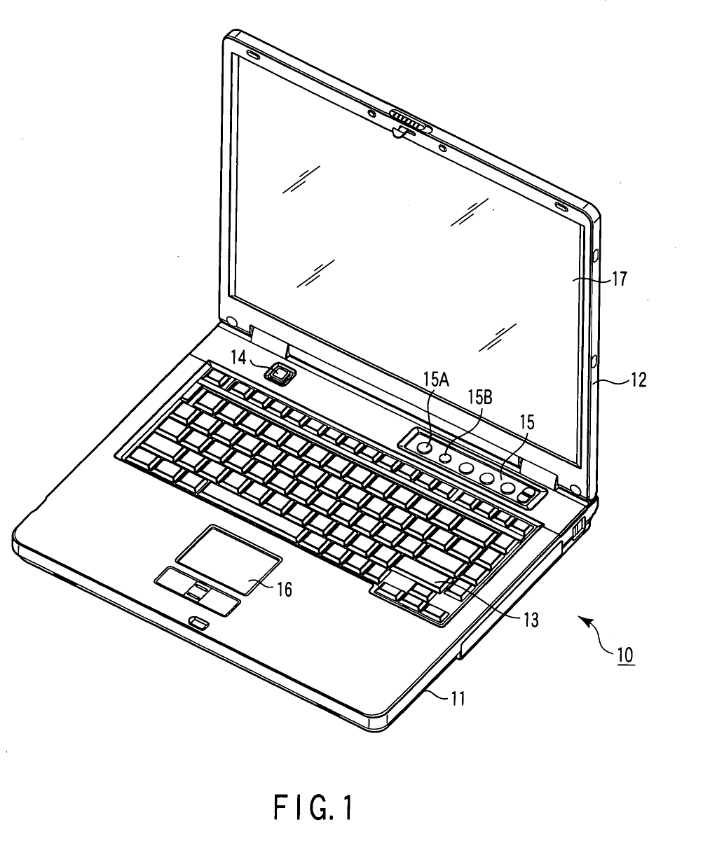

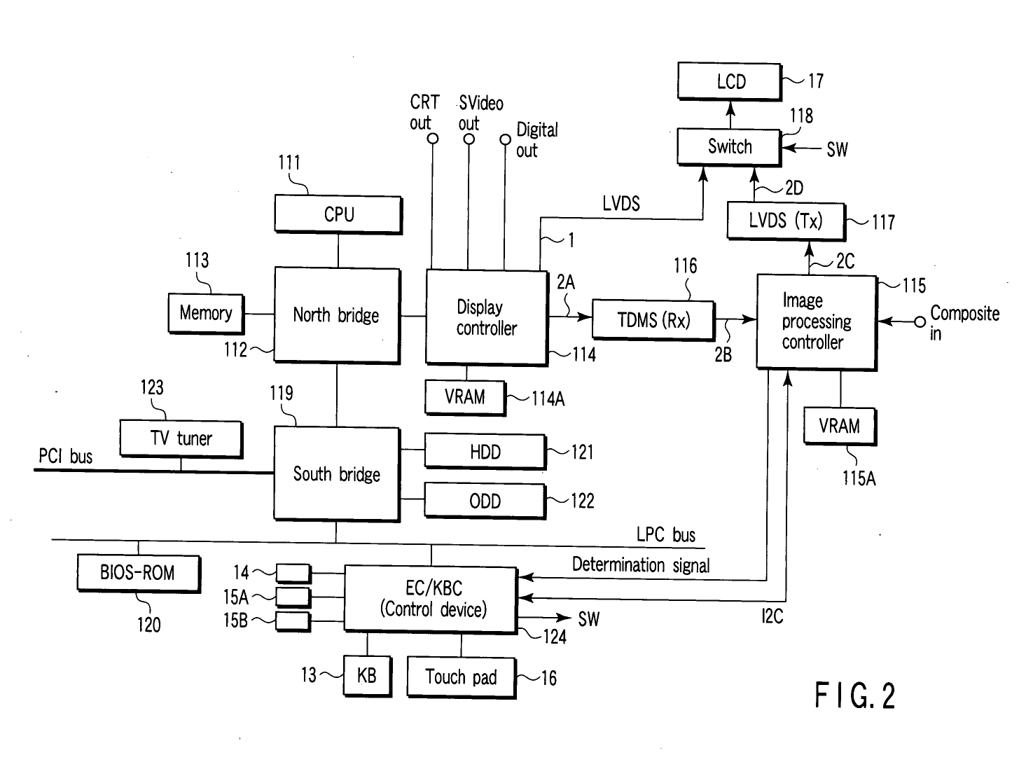

First, referring to FIGS. 1 and 2, a description is given of a configuration of an information processing apparatus according to one embodiment of the invention. This information processing apparatus is realized as, for example, a notebook personal computer 10.

FIG. 1 is a front view of the notebook personal computer 10 in a state where a display unit 12 is opened. The computer 10 includes a main unit 11 and the display unit 12. The display unit 12 incorporates therein a display device including an LCD (Liquid Crystal Display) 17, and a display screen of the LCD 17 is positioned in approximately the center of the display unit 12.

The display unit 12 is rotatably attached to the main unit 11 such that the display unit 12 can rotate between an open position and a close position. The main unit 11 includes a thin box-shaped housing. A keyboard 13, a power button 14 for turning ON/OFF power, an input operation panel 15, and a touch pad 16, etc. are arranged on a top surface of the thin box-shaped housing.

The input operation panel 15 is an input device for inputting an event corresponding to a button which is pressed, and includes a plurality of buttons for activating each of a plurality of functions. These buttons include a TV activation button 15A and a DVD/CD activation button 15B. The TV activation button 15A is a button for watching a TV program. When the TV activation button 15A is pressed down by a user, an application program for watching a TV program is automatically activated. The DVD/CD activation button 15B is a button for reproducing a video content recorded on a DVD or a CD. When the DVD/CD activation button 15 is pressed down by the user, an application program for reproducing the video content is automatically activated.

In the computer 10 according to this embodiment, in order to display image data, such as TV broadcast program data and video contents, on the LCD 17 with a high image quality, a function is provided which automatically performs an image processing with respect to the image data when watching moving images or reproducing moving image data.

Next, referring to FIG. 2, a description is given of a first exemplary system configuration of the computer 10.

As shown in FIG. 2, the computer 10 includes a CPU 111, a north bridge 112, a main memory 113, a display controller 114, an image processing controller 115, a TDMS (Rx) processing unit 116, an LVDS (Tx) processing unit 117, a switch 118, south bridge 119, a BIOS-ROM 120, a hard disk drive (HDD) 121, an optical disk drive (ODD) 122, a TV tuner 123, an embedded controller/keyboard controller IC (EC/KBC) 124, and so on.

CPU 111 is a processor provided for controlling the operation of the computer 10, and executes various application programs and an operating system loaded into the main memory 113 from the hard disk drive 121. In addition, the CPU 111 also executes a system BIOS (Basic Input Output System) which is stored in the BIOS-ROM 120. The system BIOS is a program for controlling hardware.

The north bridge 112 is a bridge device which couples between a local bus of the CPU 111 and the south bridge 119. In addition, the north bridge 112 incorporates therein a memory controller which accesses the main memory 113. The north bridge 112 also includes a function which performs communication with the display controller 114 via, for example, an AGP (Accelerated Graphics Port) bus.

The display controller 114 controls the LCD 17, which is used as a display monitor of the computer 10. The display controller 114 generates, from display data written in a video memory (VRAM) 114A, image signals which form a display image to be displayed on the LCD 17.

The image signals generated by the display controller 114 are output to each of a line 1 and a line 2A. The image signal which is output to the line 1 is formed by, for example, an 18-bit signal in an LVDS (Low Voltage Differential Signaling) format. In addition, the image signal which is output to the line 2A is formed by, for example, a 24-bit signal in a TDMS (Transition Minimized Differential Signaling) format. Further, the display controller 114 also includes an interface for outputting an analog image signal to an external CRT (Cathode Ray Tube), an interface for externally outputting the analog image signal via an S-Video terminal, and an interface for externally outputting a digital image signal via a D terminal.

The TDMS (Rx) processing unit 116 converts the 24-bit signal in the TDMS format, which signal is sent from the display controller 114 via the line 2A, into a 24-bit RGB digital signal, and sends the 24-bit RGB digital signal to the image processing controller 115 via a line 2B.

The image processing controller 115 performs image processing (hereinafter referred to as the image quality adjusting process or the adjusting process) for enhancing the image quality of the image signal which is generated by the display controller 114. The image processing controller 115 includes a video memory (VRAM) 115A. The image quality adjusting process is performed on the video memory (VRAM) 115A. The image quality adjusting process is an image processing exclusive for moving images in order to enhance the image quality of the moving images. The image quality adjusting process performs, for example, color correction (e.g., gamma correction, white balance adjustment, brightness adjustment, and contrast adjustment), sharpness adjustment, edge enhancement, and an adjusting process for improving the speed of response of the LCD 17, so as to display a smooth and high-quality moving image on the LCD 17. Each adjusting process of the image quality adjusting process is performed based on a plurality of image adjusting parameters which are sent from the embedded controller/keyboard controller IC (EC/KBC) 124. In this embodiment, an image adjusting utility program is used as a program for controlling the image quality adjusting process. The image adjusting utility program is executed on the operating system (OS) under control by the CPU 111, and displays a setting screen, such as a GUI (Graphical User Interface), on the LCD 17. The user can specify the content of the image quality adjusting process to be performed via the GUI, which is provided by the image adjusting utility program.

In addition, the image processing controller 115 can also perform an image adjusting process with respect to an image signal which is input from external video equipment via a composite input terminal.

The image signal subjected to image adjustment by the image processing controller 115 is sent to the LVDS (Tx) processing unit 117 via a line 2C. The LVDS (Tx) processing unit 117 converts the RGB digital signal, which is subjected to the image adjustment and is output from the image processing controller 115, into a signal in the LVDS (Low Voltage Differential Signaling) format, and outputs the signal in the LVDS-format to a line 2D.

The switch 118 functions as a selector which selectively outputs, to the LCD 17, one of the image signal generated by the display controller 114 and the image signal subjected to the image adjustment by the image processing controller 115. The switch 118 includes a first input terminal coupled to the line 1, a second input terminal coupled to the line 2D, and an output terminal coupled to the LCD 17. The switch 118 selects one of the first input terminal and the second input terminal in accordance with a switch control signal SW, which is supplied from the EC/KBC 124, and is configured to couple the selected input terminal to the output terminal.

The south bridge 119 controls each device on a LPC (Low Pin Count) bus. Additionally, the south bridge 119 incorporates therein an IDE (Integrated Drive Electronics) controller for controlling the HDD 121 and the ODD 122.

The optical disk drive (ODD) 122 is a drive unit for driving a storage medium such as a CD and a DVD storing a video content. The TV tuner 123 is a receiving apparatus for receiving broadcast program data such as a TV broadcast program.

The embedded controller/keyboard controller IC (EC/KBC) 124 is a control device which controls the operation of the computer 10 (the main unit 11) in conjunction with the CPU 111. The embedded controller/keyboard controller IC (EC/KBC) 124 is formed by a 1-chip microcomputer. The embedded controller/keyboard controller IC (EC/KBC) 124 also incorporates therein an embedded controller for power management, and a keyboard controller for controlling the keyboard (KB) 13 and the touch pad 16. The embedded controller/keyboard controller IC (EC/KBC) 124 also includes a function which powers ON/powers OFF the computer 10 in accordance with an operation of the power button 14 by the user, and a function which controls the image processing controller 115.

The embedded controller/keyboard controller IC (EC/KBC) 124 determines whether or not the image processing controller 115 is included in the computer 10, based on a determination signal which indicates whether or not the image processing controller 115 is included in the computer 10. The embedded controller/keyboard controller IC (EC/KBC) 124 is also coupled to a serial bus (I²C bus) in order to perform communication with the image processing controller 115. The I²C bus is used as a control line for sending a control signal (e.g., image adjusting parameters and various commands which control the image processing controller 115) to the image processing controller 115 from the embedded controller/keyboard controller IC (EC/KBC) 124.

Further, the embedded controller/keyboard controller IC (EC/KBC) 124 includes a function which supplies the above-mentioned switch control signal SW to the switch 118.

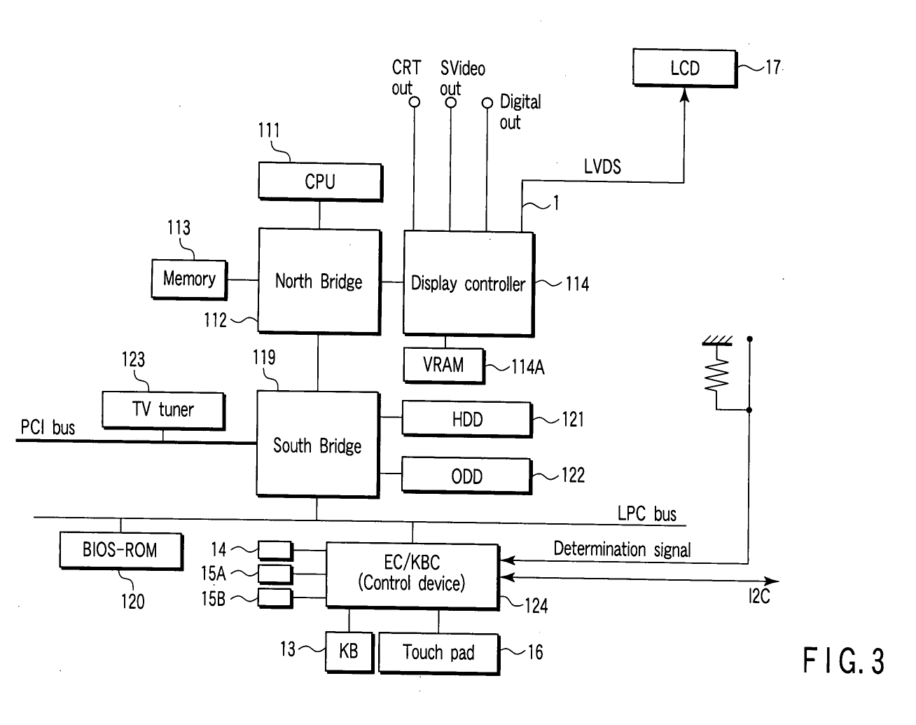

Next, referring to FIG. 3, a description is given of a second exemplary system configuration of the computer 10. The second exemplary system configuration is a system configuration obtained by eliminating, from the system configuration of FIG. 2, components such as the image processing controller 115, the video memory 115A, the LVDS (Tx) processing unit 117, and the switch 118. The embedded controller/keyboard controller IC (EC/KBC) 124 is configured to operate properly either with the system configuration of FIG. 2 or the system configuration of FIG. 3. In other words, the embedded controller/keyboard controller IC (EC/KBC) 124 can be used in common for a model including the system configuration of FIG. 3 as well as a model including the system configuration of FIG. 2.

The embedded controller/keyboard controller IC (EC/KBC) 124 performs two kinds of image quality adjusting process controls as follows, depending on whether or not the image processing controller 115 is included.

(1) First Image Quality Adjusting Process Mode (the image processing controller is included): As shown in FIG. 2, in the case where the image processing controller 115 is included, the image signal from the display controller 114 is sent to the LCD 17 via the image processing controller 115. On this occasion, the image quality adjusting process is not performed on image data written to the VRAM 114A. The embedded controller/keyboard controller IC (EC/KBC) 124 performs communication with the image processing controller 115 via the I²C bus, thereby setting the image adjusting parameters to the image processing controller 115 via the I²C bus. The image processing controller 115 performs a predetermined image quality adjusting process with respect to the image signal from the display controller 114, based on the image adjusting parameters which are set by the EC/KBC 124.

(2) Second Image Quality Adjusting Process Mode (the image processing controller is not included): As shown in FIG. 3, in the case where the image processing controller 115 is not included in the computer 10, image data subjected to the image quality adjusting process by the CPU 111 are written into the VRAM 114A, and an image signal generated from the image data is sent to the LCD 17 from the display controller 114. On this occasion, the image adjusting parameters are not sent to the image processing controller 115 from the embedded controller/keyboard controller IC (EC/KBC) 124 via the I²C bus.

As mentioned above, the embedded controller/keyboard controller IC (EC/KBC) 124 determines whether or not the image processing controller 115 is included. Only when it is determined that the image processing controller 115 is included in the computer 10, the image adjusting parameters are sent to the image processing controller 115. Then, information in accordance with whether or not the image processing controller 115 is included in the computer 10 is sent to the CPU 111 (the operating system, a TV application program reproducing moving image data such as a TV broadcast program, the image adjusting utility program, and the BIOS). In this manner, the image quality adjusting process is performed by the image processing controller 115 or the CPU 111.

If the embedded controller/keyboard controller IC (EC/KBC) 124 does not include the function which determines whether or not the image processing controller 115 is included, the embedded controller/keyboard controller IC (EC/KBC) 124 initiates communication with the image processing controller 115 via the I²C bus, irrespective of whether or not the image processing controller 115 is included. In this case, there is a possibility that the embedded controller/keyboard controller IC (EC/KBC) 124 may hang-up due to absence of a response from the image processing controller 115.

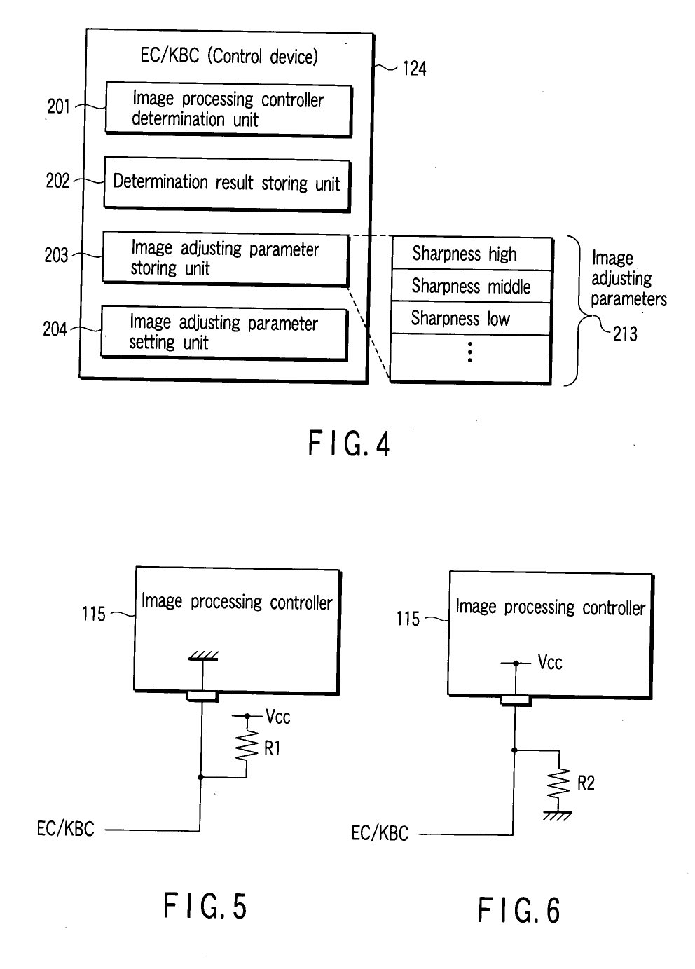

Next, referring to FIG. 4, a description is given of an exemplary configuration of the embedded controller/keyboard controller IC (EC/KBC) 124 which is used in the system configuration of the computer 10. The embedded controller/keyboard controller IC (EC/KBC) 124 includes, for example, an image processing controller determination unit 201, a determination result storing unit 202, an image adjusting parameter storing unit 203 and an image adjusting parameter setting unit 204. The image processing controller determination unit 201 determines whether or not the image processing controller 115 is included in the computer 10 by monitoring the voltage on a transmission line between the embedded controller/keyboard controller IC (EC/KBC) 124 and the image processing controller 115. In accordance with the determination result, the image processing controller determination unit 201 stores, in the determination result storing unit 202, information indicating whether or not the image processing controller 115 is included. The determination result storing unit 202 is a storing unit which stores information sent from the image processing controller determination unit 201. A plurality of image adjusting parameters 213 for performing each adjusting process (e.g., a color correction process, a sharpness adjusting process, and an edge enhancement process, etc.) of the image quality adjusting process are stored in the image adjusting parameter storing unit 203. For example, as for the sharpness adjusting process, parameters are stored which correspond to respective levels (high level, middle level, and low level, etc.) at which the sharpness adjusting process is to be performed. If the information stored in the determination result storing unit 202 is information indicating that “the image processing controller 115 is included in the computer 10”, the image adjusting parameter setting unit 204 sends, to the image processing controller 115, the image adjusting parameters 213 stored in the image adjusting parameter storing unit 203, so that the image quality adjusting process is performed with respect to the image signal which is input to the image processing controller 115.

Next, referring to FIGS. 5 and 6, a description is given of an exemplary determination process which determines whether or not the image processing controller 115 is included in the computer 10. As shown in FIG. 5, a pull-up resistor R1 is coupled to the transmission line between the embedded controller/keyboard controller IC (EC/KBC) 124 and the image processing controller 115. If the image processing controller 115 is included in the computer 10, the transmission line is connected to the ground within the image processing controller 115. Consequently, the voltage of the transmission line is at almost zero. On the other hand, if the image processing controller 115 is not included in the computer 10, the voltage of the transmission line is maintained at a high voltage. Thus, the image processing controller determination unit 201 can determine whether or not the image processing controller 115 is included in the computer 10 in accordance with the voltage of the transmission line.

In addition, as shown in FIG. 6, a pull-down resistor R2 may be coupled to a transmission line between the embedded controller/keyboard controller IC (EC/KBC) 124 and the image processing controller 115. If the image processing controller 115 is included in the computer 10, the transmission line is coupled to a power source Vcc within the image processing controller 115. Consequently, the voltage of the transmission line is at a high voltage. On the other hand, if the image processing controller 115 is not included in the computer 10, the voltage of the transmission line is at almost zero.

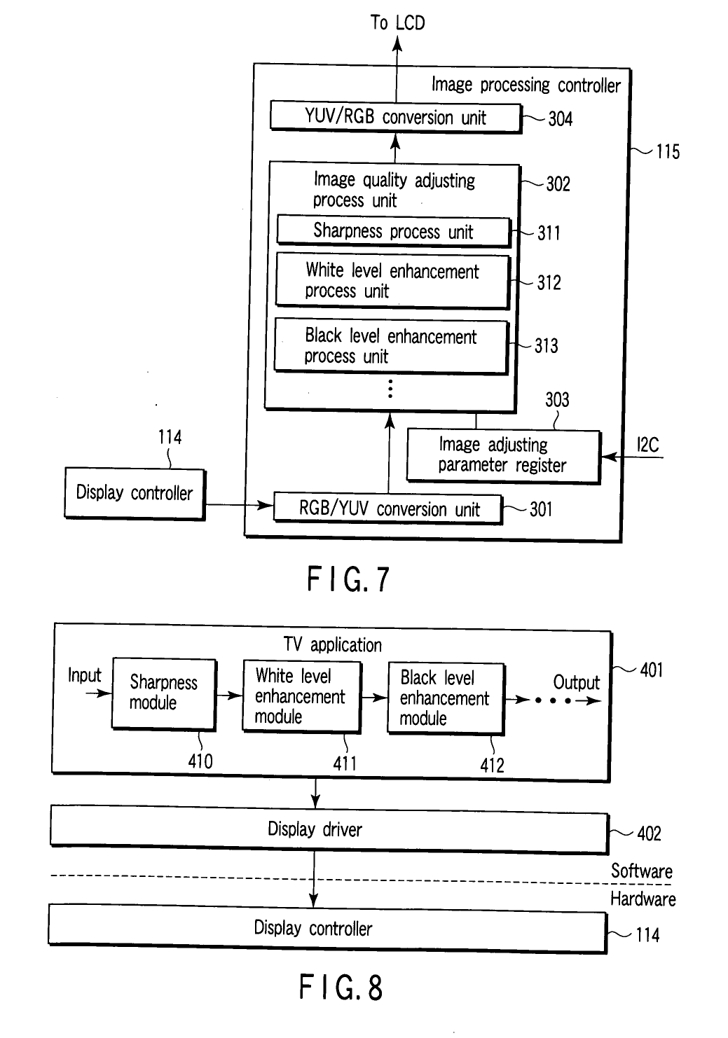

Next, referring to FIG. 7, a description is given of an exemplary configuration of the image processing controller 115.

As shown in the FIG. 7, the image processing controller 115 includes a RGB/YUV conversion unit 301, an image quality adjusting process unit 302, and a YUV/RGB conversion unit 304, and so on.

The RGB/YUV conversion unit 301 converts the image signal sent from the display controller 114 via the TDMS (Rx) processing unit 116, i.e., an 18-bit RGB digital signal, into a 24-bit YUV signal. The image quality adjusting process unit 302 includes, for example, a sharpness process unit 311, a white level enhancement process unit 312, and a black level enhancement process unit 313 for performing, on the YUV signal which is input from the RGB/YUV conversion unit 301, arithmetic processing for image quality adjustment thereof (color correction (e.g., gamma correction, white balance adjustment, brightness adjustment, and contrast adjustment), sharpness adjustment, edge enhancement, and improvement of speed of response, etc.) in accordance with the image adjusting parameters 213, which are set to an image adjusting parameter register 303 via the I²C bus. The sharpness process unit 311 performs a sharpness process for, e.g., edge enhancement. The white level enhancement process unit 312 and the black level enhancement process unit 313 perform processes for correction of the gradations of white and black, respectively. The YUV/RGB conversion unit 304 converts the image signal subjected to the image adjusting process, i.e., a 24-bit YUV signal, into an 18-bit RGB signal. This RGB signal is sent to the LVDS (Tx) processing unit 117 via the line 2C.

Next, referring to FIG. 8, a description is given of exemplary functions and configuration of a TV application program 401.

The TV application program 401 performs an image quality adjusting process in the second image quality adjusting process mode.

The TV application program 401 includes, for example, a sharpness module 410, a white level enhancement module 411, and a black level enhancement module 412 for performing, on image data to be displayed, arithmetic processing for image quality adjustment (color correction (e.g., gamma correction, and white balance adjustment), brightness adjustment, contrast adjustment, sharpness adjustment, edge enhancement, and improvement of speed of response, etc.). The sharpness module 410 performs a sharpness process for, e.g., edge enhancement. The white level enhancement module 411 and the black level enhancement module 412 perform processes for correction of the gradations of white and black, respectively.

The image data subjected to the image quality adjustment by the TV application program 401 are written into the video memory 114A of the display controller 114 via a display driver 402. The display driver 402 is software for controlling the display controller 114.

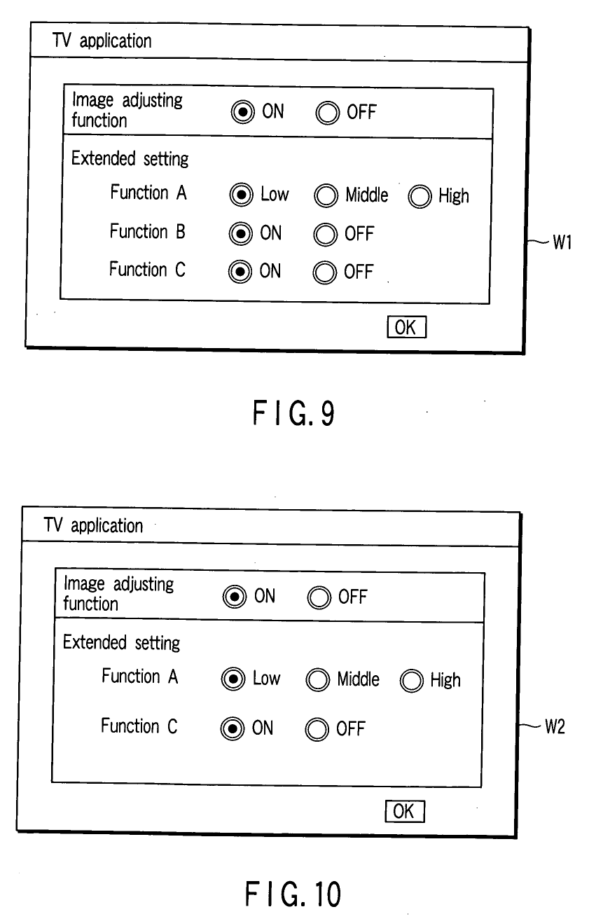

As shown in FIG. 9, in the first image quality adjustment process mode, the image adjusting utility program displays on the LCD 17 a setting screen W1 for causing the user to specify the level of each adjusting process of the image quality adjusting process (color correction (e.g., gamma correction, and white balance), brightness adjustment, contrast adjustment, sharpness adjustment, edge enhancement, and improvement of speed of response, etc.) with respect to the image data which are input to the image processing controller 115. On the setting screen W1, the user can specify functions (e.g., a function A, a function B and a function C, etc.) related to the image quality adjusting process which can be performed by the image processing controller 115.

Additionally, as shown in FIG. 10, in the second image quality adjustment process mode, the image adjusting utility program displays on the LCD 17 a setting screen W2 for causing the user to specify the level of each adjusting process of the image quality adjusting process (color correction (e.g., gamma correction, and white balance adjustment), brightness adjustment, contrast adjustment, sharpness adjustment, edge enhancement, and improvement of speed of response, etc.) performed by the CPU 111 (the TV application program 401) with respect to the image data. On the setting screen W2, the user can specify functions (e.g., the function A and the function C) related to the image quality adjusting process which can be performed by the display controller 114. The image adjusting utility program sends, to the TV application program 401, a request for image adjusting parameters corresponding to the functions which are set on the setting screen W2.

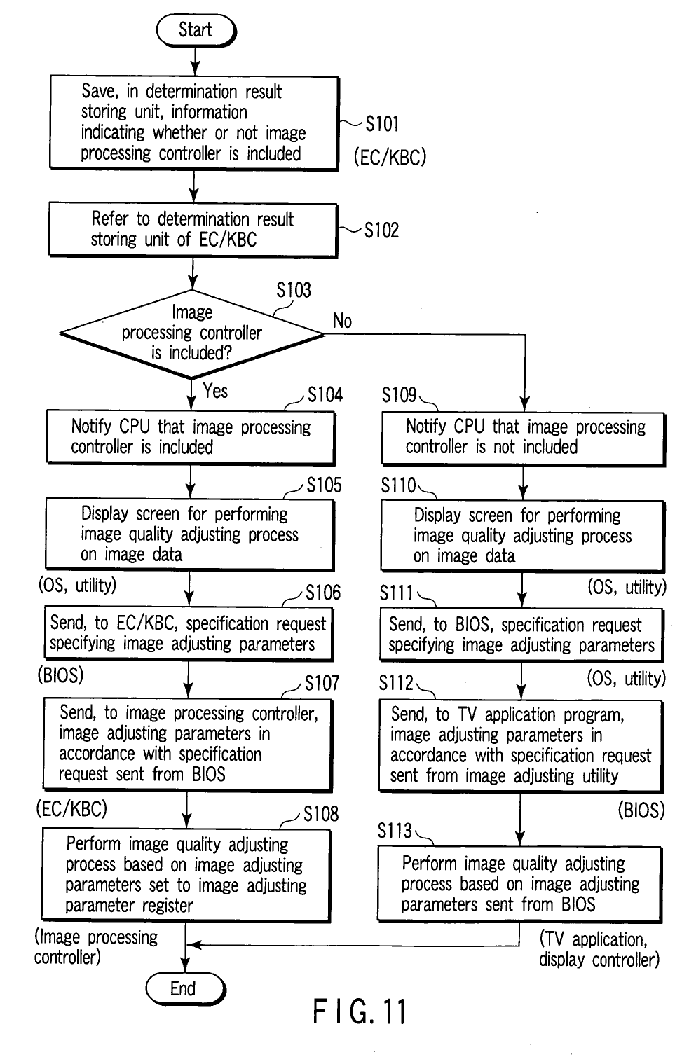

Next, referring to a flowchart of FIG. 11, a description is given of an exemplary procedure of the image adjusting process according to this embodiment.

The embedded controller/keyboard controller IC (EC/KBC) 124 determines whether or not the image processing controller 115 is included in the computer 10, and stores in the determination result storing unit 202 the information indicating whether or not the image processing controller 115 is included in the computer 10 (block S101). When the computer 10 is activated, the BIOS inquires of the embedded controller/keyboard controller IC (EC/KBC) 124 whether or not the image processing controller 115 is included. The embedded controller/keyboard controller IC (EC/KBC) 124 refers to the information stored in the determination result storing unit 202, and determines whether or not the image processing controller 115 is included in the computer 10 (block S102, block S103). If it is determined that the image processing controller 115 resides in the computer 10 (YES in block S103), the embedded controller/keyboard controller IC (EC/KBC) 124 sends the information indicating that “the image processing controller 115 is included in the computer 10” to the CPU 111 (the operating system (OS), the TV application program 401, the image adjusting utility program, and the BIOS) (block S104). The image adjusting utility program displays a setting screen for causing the user to specify the level of the image quality adjusting process (block S105). In the block S105, the image adjusting utility program displays, for example, the setting screen W1 on the LCD 17. The BIOS sends, to the embedded controller/keyboard controller IC (EC/KBC) 124, a specification request which specifies the image adjusting parameters 213 corresponding to the level of the image quality adjusting process specified on the setting screen (block S106). The embedded controller/keyboard controller IC (EC/KBC) 124 sends, to the image processing controller 115, the image adjusting parameters 213 stored in the image adjusting parameter storing unit 203 (block S107). In the block S107, the image processing controller 115 saves, in the image adjusting parameter storing unit 203, e.g., commands corresponding to the respective image adjusting parameters 213 which are sent externally. Based on the image adjusting parameters saved in the image adjusting parameter storing unit 203, the image processing controller 115 performs the image quality adjusting process with respect to the image data which are input to the image processing controller 115 (block S108).

On the other hand, if it is determined that the image processing controller 115 is not included in the computer 10 (NO in block S103), the embedded controller/keyboard controller IC (EC/KBC) 124 sends the information indicating that “the image processing controller 115 is not included in the computer 10” to the CPU 111 (the operating system (OS), the TV application program 401, the image adjusting utility program, and the BIOS) (block S109). The image adjusting utility program displays a setting screen for causing the user to specify the level of each adjusting process of the image quality adjusting process for performing the image quality adjusting process by the CPU 111 (block S110). In the block S110, the image adjusting utility program displays, e.g., the setting screen W2 on the LCD 17. The image adjusting utility program sends, to the BIOS, a specification request which specifies the image adjusting parameters corresponding to the level of image adjustment specified on the setting screen W2 (block Sill). The BIOS sends, to the TV application program 401, values corresponding to, for example, the image adjusting parameters, in accordance with the specification request sent from the image adjusting utility program (block S112). Based on the image adjusting parameters sent from the BIOS, the TV application program 401 performs the image quality adjusting process with respect to image data (block S113).

As mentioned above, in this embodiment, it is possible to use the same embedded controller/keyboard controller IC (EC/KBC) 124 in common between the two different kinds of system configuration. In addition, it is possible to perform image processing for achieving a high-quality image with either one of the system configurations.

Further, in this embodiment, the description is given of the case where the image adjusting parameter storing unit 203 within the embedded controller/keyboard controller IC (EC/KBC) 124 stores the image adjusting parameters 213. However, the BIOS-ROM 120 storing the image adjusting parameters 213 in advance may be provided in common for the model including the system configuration of FIG. 2 and the model including the system configuration of FIG. 3. In this case, if it is determined that the image processing controller 115 is included in the computer 10, the embedded controller/keyboard controller IC (EC/KBC) 124 obtains the image adjusting parameters 213 from the BIOS-ROM 120, and sets the obtained image adjusting parameters 213 to the image processing controller 115.

Additionally, in this embodiment, the description is given of the case where the image quality adjusting process is performed in accordance with the level specified on the setting screen for specifying the image adjusting parameters. However, in the case where, for example, the operation mode of the computer 10 is an automatic adjusting mode, the setting screen may not be displayed. In this case, the image quality adjusting process is automatically performed based on parameters which are specified in advance, depending on whether the mode is the first image quality adjusting process mode or the second image quality adjusting process mode.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus, comprising:
a body;
a processor provided within the body;
a control device provided within the body and configured to control an operation of the body in conjunction with the processor; and
a storing unit configured to store an image adjusting parameter,
the control device including:
a determination unit configured to determine whether or not an image processing controller is included in the body, the image processing controller performing, based on the image adjusting parameter, predetermined image processing with respect to image data to be displayed on a display apparatus; and
a setting unit configured to set, when the determination unit determines that the image processing controller is included in the body, the image adjusting parameter stored in the storing unit to the image processing controller.

2. The information processing apparatus according to claim 1, wherein the control device includes a sending unit configured to send, when the determination unit determines that the image processing controller is not included in the body, to the processor, information indicating that the image processing controller is not included in the body, and
wherein, when the processor receives the information sent from the control device, the processor performs predetermined image processing with respect to the image data.

3. The information processing apparatus according to claim 1, wherein the control device includes a sending unit configured to send, when the determination unit determines that the image processing controller is not included in the body, to the processor, information indicating that the image processing controller is not included in the body, and
wherein the processor includes:
a display unit configured to display, when the processor receives the information sent from the control device, on the display apparatus, a setting screen for causing a user to specify a content of image processing to be performed with respect to the image data; and
an image processing unit configured to perform the image processing with respect to the image data in accordance with the content specified on the setting screen displayed by the display unit.

4. The information processing apparatus according to claim 1, wherein the image processing includes a process which adjusts an image quality of the image data.

5. The information processing apparatus according to claim 1, wherein the setting unit includes a sending unit configured to send the image adjusting parameter to the image processing controller by performing communication with the image processing controller via a bus which couples between the image processing controller and the control device.

6. The information processing apparatus according to claim 1, wherein the control device includes a basic input/output system and the storing unit is included in the basic input/output system.

7. A system control method applied to an information processing apparatus including a body, a processor provided within the body, and a control device provided within the body and configured to control an operation of the body in conjunction with the processor, the system control method comprising:
performing, by the control device, a process which determines whether or not the image processing controller is included in the body, the image processing controller performing, based on an image adjusting parameter, predetermined image processing with respect to image data to be displayed on a display apparatus; and
when it is determined that the image processing controller is included in the body, performing, by the control device, a process which sets, to the image processing controller, the image adjusting parameter stored in a storing unit within the information processing apparatus.

8. The system control method according to claim 7, further comprising:
when it is determined that the image processing controller is not included in the body, sending, from the control device to the processor, information indicating that the image processing controller is not included in the body,
wherein, when the processor receives the information sent from the control device, the processor performs predetermined image processing with respect to the image data.

9. The system control method according to claim 7, further comprising:
when it is determined that the image processing controller is not included in the body, sending, from the control device to the processor, information indicating that the image processing controller is not included in the body,
wherein, when the processor receives the information sent from the control device, the processor displays on the display apparatus a setting screen for causing a user to specify a content of image processing to be performed with respect to the image data, and performs the image processing with respect to the image data in accordance with the content specified on the setting screen.

10. The system control method according to claim 7, wherein the image processing includes a process which adjusts an image quality of the image data.

11. The system control method according to claim 7, wherein performing the process which sets, to the image processing controller, the image adjusting parameter includes sending the image adjusting parameter to the image processing controller by performing communication with the image processing controller via a bus which couples between the image processing controller and the control device.

12. An information processing apparatus, comprising:
a storing unit configured to store a parameter; and
a determination unit configured to determine whether or not a first control unit configured to perform a first predetermined process with respect to data is included in the information processing apparatus,
wherein, when the determination unit determines that the first control unit is included in the information processing apparatus, the determination unit sets the parameter stored in the storing unit to the first control unit, and the first control unit performs the first predetermined process with respect to the data based on the set parameter.

13. The information processing apparatus according to claim 12, further comprising:
a second control unit configured to perform a second predetermined process with respect to the data,
wherein, when the determination unit determines that the first control unit is not included in the information processing apparatus, the second control unit performs the second predetermined process with respect to the data.

14. The information processing apparatus according to claim 12, wherein the determination unit determines whether or not the first control unit is included in the information processing apparatus based on a determination signal from the first control unit.

15. The information processing apparatus according to claim 12, wherein the determination unit determines whether or not the first control unit is included in the information processing apparatus by monitoring a voltage of a transmission line between the determination unit and the first control unit.

16. The information processing apparatus according to claim 15, further comprising:
a pull-up resistor coupled to the transmission line between the determination unit and the first control unit,
wherein the determination unit determines whether or not the first control unit is included in the information processing apparatus depending on the voltage of the transmission line.

17. The information processing apparatus according to claim 15, further comprising:
a pull-down resistor coupled to the transmission line between the determination unit and the first control unit,
wherein the determination unit determines whether or not the first control unit is included in the information processing apparatus depending on the voltage of the transmission line.

18. The information processing apparatus according to claim 12, further comprising:
a display unit; and
a second control unit configured to perform a second predetermined process with respect to the data,
wherein the second control unit displays, on the display unit, a setting screen for causing a user to specify a parameter, and
the storing unit stores the parameter specified by the user via the setting screen displayed on the display unit.

19. The information processing apparatus according to claim 12, further comprising:
a second control unit configured to perform a second predetermined process with respect to the data,
wherein, when the determination unit determines that the first control unit is not included in the information processing apparatus, the second control unit performs the second predetermined process based on the parameter specified by the user via the setting screen displayed on the display unit.
